(19) United States
(12) Patent Application Publication
(10) Pub. No.: US 2003/0035962 A1
(43) Pub. Date: Feb. 20, 2003

(54) Binding tape for golf club grip

(76) Inventor: Mao-Hsiu Wang, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 10/179,279

(22) Filed: Jun. 26, 2002

(30) Foreign Application Priority Data
Aug. 20, 2001 (TW) 90214184

(51) Int. Cl. B32B 27/00

(52) U.S. Cl. 428/423.1

(57) ABSTRACT

A binding tape for golf club grip is constructed having a non-woven tensile layer, a handhold layer made of polyurethane foam bonded to the tensile layer at one side, and a shock-absorbing base layer bonded to the tensile layer at the other side. The thickness ratio of the tensile layer, the handhold layer, and the shock-absorbing base layer is at 0.2:0.3:1.5˜1:1:1. The total thickness of the binding tape is within 1.3 mm˜2.0 mm.

### BACKGROUND OF THE INVENTION

1. Field of the Invention

The present invention relates to a binding tape for sports ware and, more specifically, to a binding tape for golf club grip.

2. Description of the Related Art

Previously, winding a long, narrow strip of genuine leather on the shaft of the golf club made the grip of a golf club. Nowadays, polyurethane has been commonly used for making binding tapes for golf club grip. There are known binding tapes that comprise a non-woven fabric base layer of entangled fibers and a polyurethane foam layer bonded to the non-woven fabric base layer for comfortable and positive gripping of the hands. The non-woven fabric base layer of entangled fibers reinforces the structural strength of the binding tape. The polyurethane foam layer is soft and shock absorptive. There are also known binding tapes that comprise a shock-absorbing base layer (for example, rubber) and a soft face layer of polyurethane foam bonded to the shock-absorbing base layer. The soft face layer of polyurethane foam enables the user to grip the binding tape comfortably positively. The shock-absorbing base layer eliminates or reduces transmission of shock waves from the shaft of the golf club to the user's hands.

According to the aforesaid prior art designs, a binding tape of genuine leather provides a poor shock-absorbing effect and tends to cause the user's hands to ache. A binding tape of the combination of polyurethane foam and non-woven fabric is comfortable in use, however its shock absorbing power is still not sufficient. A binding tape of the combination of polyurethane foam and shock-absorbing base layer provides a good shock-absorbing effect, and is comfortable in use for positive gripping of the hands. However, the manufacturing cost of a binding tape of the combination of polyurethane foam and shock-absorbing base layer is high because it is difficult to bond polyurethane foam to the shock-absorbing base layer. Bonding polyurethane foam to the shock-absorbing base layer requires a special technique. Another drawback of the binding tape of the combination of polyurethane foam and shock-absorbing base layer is its low tensile strength. When winding the binding tape on the shaft of a golf club, the polyurethane foam layer tends to be stretched and broken.

### SUMMARY OF THE INVENTION

The present invention has been accomplished to provide a binding tape for golf club grip, which eliminates the aforesaid drawbacks. It is the main object of the present invention to provide a binding tape for golf club grip, which provides a nice touch and good shock absorbing effect.

It is another object of the present invention to provide a binding tape for golf club grip, which does not slip easily when held in hand.

It is still another object of the present invention to provide a binding tape for golf club grip, which is easy and inexpensive to manufacture.

To achieve these objects of the present invention, the binding tape comprises a tensile layer made of non-woven fabric, a handhold layer made of polyurethane compound bonded to one side of the tensile layer, and a shock-absorbing base layer bonded to the other side of the tensile layer opposite to the handhold layer. The total thickness of the binding tape is within 1.3 mm˜2.0 mm. Further, the thickness ratio of the tensile layer, the handhold layer, and the shock-absorbing base layer is at 0.2:0.3:1.5˜1:1:1.

### BRIEF DESCRIPTION OF THE DRAWINGS

FIG. 1 is a schematic drawing showing a binding tape wound round a golf club shaft according to a preferred embodiment of the present invention.

FIG. 2 is an extended out view in an enlarged scale of a part of the binding tape shown in FIG. 1.

FIG. 3 is a sectional view in an enlarged scale taken along line 3-3 of FIG. 1.

### DETAILED DESCRIPTION OF THE PREFERRED EMBODIMENT

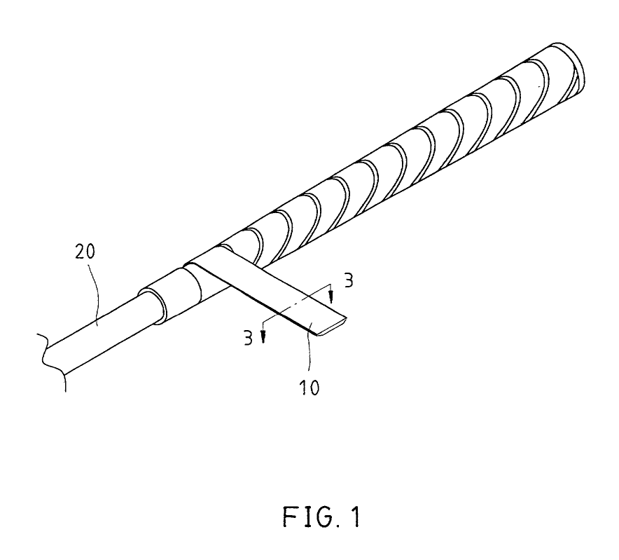

Referring to FIG. 1, a binding tape 10 is spirally wound round one end of a sleeve 20 which is sleeved onto the shaft of a golf club, forming a grip.

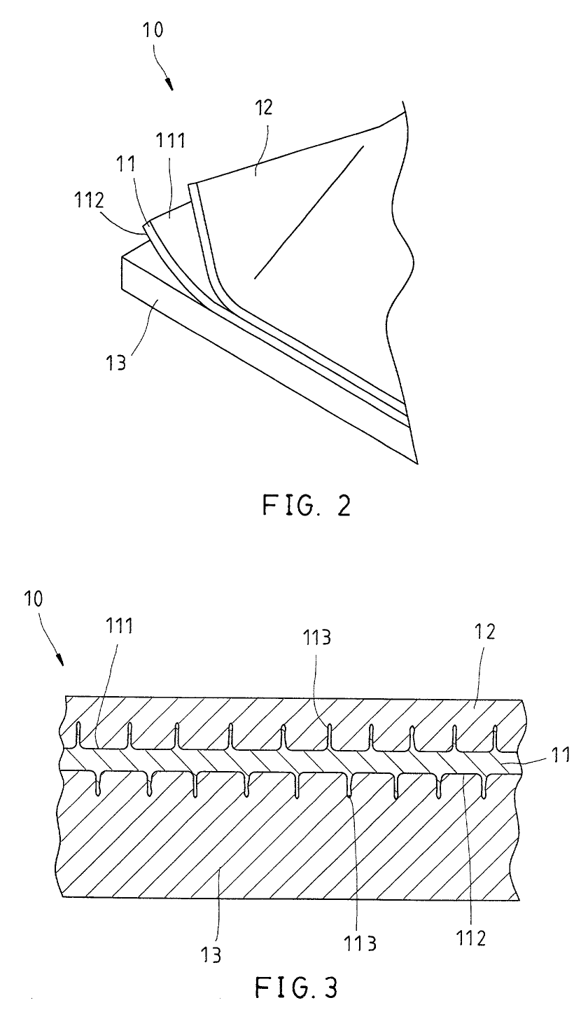

Referring to FIGS. 2 and 3, the binding tape 10 comprises a tensile layer 11, a handhold layer 12, and a shock-absorbing base layer 13. The tensile layer 11 is a non-woven fabric of entangled fibers 113. The thickness of the tensile layer 11 is preferably within about 0.2 mm˜0.6 mm. According to the present preferred embodiment, the thickness of the tensile layer 11 is 0.3 mm. The tensile layer 11 has a top face 111 and a bottom face 112 opposite to the top face 111.

The handhold layer 12 is molded from a polyurethane compound on the top face 111 of the tensile layer 11 through a foaming process. The thickness of the handhold layer 12 is preferably within about 0.3 mm˜0.6 mm. According to the present preferred embodiment, the thickness of the handhold layer 12 is 0.3 mm.

The shock-absorbing base layer 13 is made of rubber or plastics of high coefficient of elasticity, and adhered to the bottom face 112 of the tensile layer 11. The thickness of the shock-absorbing base layer 13 is preferably within about 0.6 mm˜1.5 mm. According to the present preferred embodiment, the thickness of the shock-absorbing base layer 13 is 1.3 mm.

Based of the aforesaid construction, the binding tape 10 is a long, narrow tape of about 1.9 mm thick. When winding the binding tape 10 spirally around the sleeve 20 of the golf club shaft, the shock-absorbing base layer 13 is closely attached to the surface of the sleeve 20, keeping the handhold layer 12 exposed to the outside for the holding of the user's hands.

The binding tape 10 achieves various advantages as outlined hereinafter.

1. Shock-Absorbing Effect:

Because the shock-absorbing base layer is made of rubber or plastics of high coefficient of elasticity, the binding tape absorbs shocks from the shaft efficiently upon striking of the golf club against the ball, reducing transmission of shocks to the user's hands.

2. Comfortable Holding:

Because the handhold layer is made of a soft material, i.e. polyurethane, and exposed to the outside for the holding of the user's hands, the binding tape provides a nice touch to the user's hands, and the user can holds the golf club positively in hand.

3. High Tensile Strength:

Because the handhold layer and the shock-absorbing base layer are respectively bonded to the top and bottom faces of the tensile layer, the tensile layer reinforces the structural strength of the binding tape against stretching.

4. Proper Thickness:

The total thickness of the binding tape is within about 1.8 mm˜2.0 mn, it is best fit for the holding of the hands. The user feels comfortable when holding the grip of the golf club.

5. Low Manufacturing Cost:

The fabrication of the tensile layer, the handhold layer, and the shock-absorbing base layer is simple and inexpensive. BY means of the tensile layer, the shock-absorbing base layer and the handhold layer can easily be fastened to the opposite sides of the tensile layer.

According to tests, the thickness ratio of the tensile layer, the handhold layer, and the shock-absorbing base layer is preferably at 0.2:0.3:1.5˜1:1:1. The thickness of the tensile layer, the handhold layer, and the shock-absorbing base layer can be relatively adjusted subject to the range of this thickness ratio.

A prototype of binding tape for golf club grip has been constructed with the features of the annexed drawings of FIGS. 13. The binding tape for golf club grip functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A binding tape for golf club grip comprising:
a tensile layer made of non-woven fabric;
a handhold layer made of polyurethane compound bonded to one side of said tensile layer; and
a shock-absorbing base layer bonded to one side of said tensile layer opposite to said handhold layer;
wherein the thickness ratio of said tensile layer, said handhold layer, and said shock-absorbing base layer is at 0.2:0.3:1.5˜1:1:1, and the total thickness of the binding tape is within 1.3 mm˜2.0 mm.

2. The binding tape as claimed in claim 1, wherein said shock-absorbing base layer is made of rubber.

3. The binding tape as claimed in claim 1, wherein said shock-absorbing base layer is made of plastics.

4. The binding tape as claimed in claim 1, wherein said handhold layer is made of polyurethane foam.
